(19) United States
(12) Patent Application Publication
(10) Pub. No.: US 2022/0055774 A1
(43) Pub. Date: Feb. 24, 2022

(54) OPTO-MECHANIC DRIVEN LASER-BORON FUSION FOR DRIVING OF SPACECRAFTS

(71) Applicants: Heinrich HORA, Poing (DE); George H. MILEY, Champaign, IL (US)

(72) Inventors: Heinrich HORA, Poing (DE); George H. MILEY, Champaign, IL (US)

(21) Appl. No.: 16/999,716

(22) Filed: Aug. 21, 2020

(51) Int. Cl. B64G 1/40; G21D 5/02; G21B 1/05; G21B 1/23

(52) U.S. Cl. CPC B64G 1/408; G21B 1/23; G21B 1/05; G21D 5/02

(57) ABSTRACT

A propulsion method including the steps of providing a vehicle comprising a cylindrical reactor unit; conducting a nuclear fusion reaction in the cylindrical reactor unit; and deflecting a pulse of electrically charged ions from the cylindrical reactor unit in one direction in a counter-parabolic electrical field to accelerate a surface of the parabolic wall in an opposite direction so as to propel the vehicle.

### BACKGROUND OF THE INVENTION

### 1. Field of Invention

This invention relates to vehicle propulsion systems and methods, and more particularly to nuclear propulsion systems and methods.

### 2. Description of Related Art

The propulsion of rocket systems for space vehicles was realized with a number of different devices. The aim is to generate the highest possible specific impulse while at the same time keeping the weight of fuel as low as possible. When using chemical fuel, there are limits that have been optimized as much as possible in the various manufactured spacecraft. When using nuclear fuel, the reaction energy, which is about ten million times greater, will be available, but according to previous knowledge such drives have not been realized. One problem is the enormously dangerous radioactive pollution, even if it would be very dilute in space.

It was thought since long ago that one of the very rare possibilities of nuclear energy generation is used without primary generation of radioactivity, as is the case with the nuclear fusion of light hydrogen H with the Boron isotope 11 (HB11 fusion). Proposals have repeatedly been made known about this, although HB11 fusion is extremely difficult to achieve the approximately five orders of magnitude easier fusion of heavy and very heavy hydrogen, deuterium D and tritium T (DT fusion), the implementation of which in controlled nuclear reactors has so far been carried out in spite of an enormous amount of research has not succeeded, even if one has already come quite close to a breakthrough.

The five orders of magnitude more difficult HB11 fusion than DT is the result when both types of fusion are carried out under thermal equilibrium. To ignite the 10 million times more efficient energy yield of the nuclear reaction compared to chemical reactions were examined in a thermal equilibrium with the then necessary temperatures are well over ten million degrees for DT and for HB11 in the range of up to a further ten times higher temperatures. These conditions can only be broken if the reactions can be generated under non-thermal equilibrium, as formulated as a postulate (Hora 1988). Various proposals for this are known if the reactions are attempted in a diluted plasma with ion currents at very low density, known under tri-alpha fusion or with inertial confinement (electrostatic confinement), IEC reactions, etc. None of these HB11 fusion methods has so far been measured in power generators.

Extreme non-thermal equilibrium conditions in fusion plasmas can be expected when using extremely short (picosecond) laser pulses with extremely high power (tera- to multiple petawatts). These predictions were obtained from the theory with computer results as early as 1977 (see FIG. 5 of Hora et al. 2017) when the thermal pressure in an irradiated, approximately solid-state fusion fuel was lower than the pressure from the electric field of the laser beam. The resulting nonlinear forces from the laser produce an ultra-high acceleration of plasma blocks in the comparatively little heated plasma. The laser energy was then converted into the kinetic energy of a macroscopic laser block at an extremely high speed with almost no heating. Exactly this predicted ultra-high acceleration was measured by Sauerbrey (1996).

With these plasma blocks, one can calculate the ignition of DT fusion reactions in solid-state fuel according to previous calculations by Chu and Bobin from 1972, which conditions were completely excluded for this time. These calculations were brought up to date and evaluated for the HB11 reaction for the first time (Hora et al. 2010). The big surprise was that the ignition conditions for HB11 were no longer hundreds or thousands of times heavier than for DT, but about the same. The five orders of magnitude were thus skipped. But that wasn't enough for a reactor. However, if one adds that the HB11 calculation like that of DT binary reactions was used pessimistically, contrary to the fact that with each HB11 reaction three harmless helium nuclei (alpha particles) of 3 MeV energy are generated and these generate an avalanche-like chain reaction, a total of four more, i.e., nine orders of magnitude bridging HB11 can be calculated (Eliezer et al. 2016). The historically first and so far only HB11 reactions were measured with lasers—2005 a thousand reactions by laser shot by Belyaev et al., 2013 more than a million reactions by Christine Labaune et al, and 2014 one billion (Picciotto et al. 2014). With the latter measurement, the nine orders of magnitude bridging were measured and explained (Hora et al. 2015, see also arXiv 1412.4190) in accordance with the theory (Hora et al. 2018). With these results, a laser-boron fusion reactor was developed, as described in the abstract of U.S. Ser. No. 10/410,752 B2.

All references cited herein are incorporated herein by reference in their entireties.

### BRIEF SUMMARY OF THE INVENTION

A first aspect of the invention is a propulsion method including the steps of: providing a vehicle comprising a cylindrical reactor unit; conducting a nuclear fusion reaction in the cylindrical reactor unit; and deflecting a pulse of electrically charged ions from the cylindrical reactor unit in one direction in a counter-parabolic electrical field to accelerate a surface of the parabolic wall in an opposite direction so as to propel the vehicle.

In certain embodiments, the vehicle is a space vehicle.

In certain embodiments, the nuclear fusion reaction is a multiplicative avalanche reaction.

In certain embodiments, the nuclear fusion reaction is a fusion reaction of hydrogen with boron isotope 11.

In certain embodiments, the nuclear fusion reaction is conducted in a spherical center of the cylindrical reactor unit, which is maintained by a magnetic field of at least 100 Tesla.

In certain embodiments, a timing for generating a magnetic trap with a time of initiation of the laser pulse on the fusion fuel is optimized in the cylindrical volume of the fusion fuel.

In certain embodiments, a distance between the cylindrical reactor unit and a focus of the parabolic wall has a minimum size with no dark discharge between the parabolic wall and the cylindrical reactor unit.

A second aspect of the invention is a vehicle comprising a cylindrical reactor unit configured to conduct a nuclear fusion reaction therein and a counter-parabolic electrical field to deflect a pulse of electrically charged ions from the cylindrical reactor unit to accelerate a surface of a parabolic wall in an opposite direction so as to propel the vehicle.

### DETAILED DESCRIPTION OF PREFERRED EMBODIMENTS OF THE INVENTION

The invention described here builds on the use of the HB11 reaction, especially after the disadvantageous five orders of magnitude compared to DT due to the extreme thermal non-equilibrium conditions according to the results in (Hora et al. 2010) through the use of very extreme laser pulses became known for igniting the reaction and became interesting as a propulsion system for spacecraft (Miley et al. 2009; Hora et al. 2011). According to the invention, the further progress with the measured nine orders of magnitudes of bridging is applied in the following form of combination.

The reaction unit, which is preferably the reaction unit shown in FIG. 1 of U.S. Ser. No. 10/410,752 B2 in the middle of the spherical energy reactor of FIG. 3 of U.S. Ser. No. 10/410,752 B2, is taken over with the laser pulses 1 and 2 acting and brought into the parabolic focus of the rocket drive and per laser shot renewed in this position with every reaction. The wall of the focus is charged against the reaction unit to at least −1.5 megavolts of counter potential, so that all alpha particles emitted from the reactor unit are deflected into a parallel beam and a recoil occurs on the focus wall, which corresponds to almost the entire momentum of the generated alpha particles. Almost the entire momentum of the particles of the fusion reaction then goes into the acceleration of the parabolic wall.

The introduction of the reactor unit into the focus with the necessary charging takes place in the same way as in the spherical reactor according to U.S. Ser. No. 10/410,752 B2 in the description of the cylindrical coil capacitor shown there in FIG. 1 explained with the arrangement of the cylindrical coil-condensor. The cylindrical fusion fuel is housed coaxially in the coil and captured in the magnetic field generated by the laser. The fusion reaction is ignited by the picosecond petawatt laser pulse, which is incident on the circular end face of the cylindrical fusion fuel.

While the invention has been described in detail and with reference to specific examples thereof, it will be apparent to one skilled in the art that various changes and modifications can be made therein without departing from the spirit and scope thereof.

### REFERENCES CITED

1. U.S. Ser. No. 10/410,752 B2
2. Hora (1988). Nonlinear effects and nonthermal plasmas. Nuclear Instruments and Methods in Physics Research Section A: Accelerators, Spectrometers, Detectors and Associated Equipment, 271(1), 117-125.
3. Hora et al. (2017). Non-thermal laser driven plasma-blocks for proton boron avalanche fusion as direct drive option. Matter and Radiation at Extremes, 2(4), 177-189.
4. Sauerbrey. (1996). Acceleration in femtosecond laser-produced plasmas. Physics of Plasmas, 3(12), 4712-4716.
5. Hora et al. (2010) Energy and Environment Science, 3 479.
6. Eliezer et al. (2016). Avalanche proton-boron fusion based on elastic nuclear collisions. Physics of Plasmas, 23(5), 050704.
7. Picciotto et al. (2014). Boron-proton nuclear-fusion enhancement induced in boron-doped silicon targets by low-contrast pulsed laser. Physical Review X, 4(3), 031030.
8. Hora et al. (2015). Fusion energy using avalanche increased boron reactions for block-ignition by ultrahigh power picosecond laser pulses. Laser and particle Beams, 33(4), 607-619.
9. Hora et al. (2018). Laser boron fusion reactor with picosecond petawatt block ignition. IEEE Transactions on Plasma Science, 46(5), 1191-1197.
10. Miley et al. (2009). Fast Ignition ICF Fusion With Bose-Einstein Cluster Targets for p-B11 Powered Space Propulsion. In 45th AIAA/ASME/SAE/ASEE Joint Propulsion Conference & Exhibit (p. 5338).
11. Hora et al. (2011). Strong shock-phenomena at petawatt-picosecond laser side-on ignition fusion of uncompressed hydrogen-boron11. Astrophysics and Space Science, 336(1), 225-228.

What is claimed is:

1. A propulsion method comprising:
providing a vehicle comprising a cylindrical reactor unit;
conducting a nuclear fusion reaction in the cylindrical reactor unit; and
deflecting a pulse of electrically charged ions from the cylindrical reactor unit in one direction in a counter-parabolic electrical field to accelerate a surface of the parabolic wall in an opposite direction so as to propel the vehicle.

2. The propulsion method of claim 1, wherein the vehicle is a space vehicle.

3. The propulsion method of claim 1, wherein the nuclear fusion reaction is a multiplicative avalanche reaction.

4. The propulsion method of claim 1, wherein the nuclear fusion reaction is a fusion reaction of hydrogen with boron isotope 11.

5. The propulsion method of claim 1, wherein the nuclear fusion reaction is conducted in a spherical center of the cylindrical reactor unit, which is maintained by a magnetic field of at least 100 Tesla.

6. The propulsion method of claim 1, wherein a timing for generating a magnetic trap with a time of initiation of the laser pulse on the fusion fuel is optimized in the cylindrical volume of the fusion fuel.

7. The propulsion method of claim 1, wherein a distance between the cylindrical reactor unit and a focus of the parabolic wall has a minimum size with no dark discharge between the parabolic wall and the cylindrical reactor unit.
